(19) United States
(12) Patent Application Publication
(10) Pub. No.: US 2008/0031098 A1
(43) Pub. Date: Feb. 7, 2008

(54) Servo architecture to minimize access time in optical disk drive

(76) Inventor: Feihong Zhu, Fremont, CA (US)

Correspondence Address: Feihong Zhu, 39340 Canyon Heights Dr., Fremont, CA, 94539, US

(21) Appl. No.: 11/644,020

(22) Filed: Dec. 22, 2006

Related U.S. Application Data
(60) Provisional application No. 60/789,802, filed on Apr. 6, 2006.

(51) Int. Cl. G11B 7/00

(52) U.S. Cl. 369/44.11

(57) ABSTRACT

An apparatus and method are disclosed to minimize seek time for dual stage actuator from both theoretical and real application viewpoints in optical disk drive application, where 1) a head mounted on a sled is positioned by a sled actuator; 2) A lens is mounted on the head with spring connection and optically coupled to a photo-sensor. A tracking actuator positions the lens with respect to tracks on the disk. The algorithms and designs include: a) dual stage mechanical models description from the real application consideration for track following and seek modes, respectively. The dual stage mechanical models describe the motion of lens and head driven by tracking and sled actuator in each mode. Meanwhile a simplified dual stage mechanical model with reduced parameters is given to decouple the link between lens and head; b) simplified model in track following mode and LHCE estimator design in track following mode. The LHCE is defined as error between head and lens physical centers in the dual stage mechanical moving direction. The LHCE estimator designs are based on simplified mechanical models in order to make head center following lens center movement in track following mode; c) a control architecture to position lens and sled based on LHCE estimator designs in seek modes; d) an architecture to switch design rules between tracking mode and seek mode. The method can also be applied to those cases where optical writer mechanism does not have LHCE sensor.

### CROSS-REFERENCE TO RELATED APPLICATIONS

This application claims the benefit of provisional patent application Ser. No. 60/789,802, Filed Apr. 6, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to servo architecture to move dual stage mechanism with minimal access time for optical storage device.

2. Prior Art

### 1. Related Application Environment of the Invention

On the compact optical disk, data is stored in the form of pits and land patterned in a radial track. The track is formed in one spiral line extending from the inner radius of the disk to the outer edge. A pit is a location on the disk where data has been recorded by creating a depression in the surface of the disk with respect to the lands. The lands are the areas between the pits in the tangential direction. The reflectivity of the pits is less than the reflectivity of the lands. To store digital information, the length of the pits and lands are controlled according to a predefined encoding format. When reading information from the disk, light from a laser beam is directed onto the track and the light beam is reflected back to a photo-sensor. Since the pits and land have different reflectivity, the amount of reflected light changes at the transitions between the pits and the lands. In other words, the encoded pattern of the pits and lands modulates the reflected light beam. The photo-sensor receives the reflected light beam, and outputs a modulated signal including two type of information. One is data information typically referred to as a RF signal that is proportional to the energy of the light in the reflected light beam. Another is servo information used as feedback signal of the positioning system.

In an optical disk drive, a dual stage moving system is used to position lens on optical disk. The dual stage moving system comprises photo-sensor, lens, tracking and sled actuator. Optical head assembly includes the photo-sensor, a tracking actuator and a lens. The optical head assembly is mounted on a sled. The tracking actuator is supported by the sled. The lens is not directly attached to the sled, but is coupled to the tracking actuator by spring. The lens is positioned between the photo-sensor and the disk to transmit the light beam from the laser onto the disk surface and to transmit the reflected light beam to the photo-sensor. The tracking and sled actuators position the lens and head with respect to the spiral track. The sled is driven by a sled motor that positions the head assembly radially across the disk. The tracking actuator is a voice coil motor (VCM) that positions the lens within the limits of the sled. Because the geometry of the photo-sensor is large with respect to a single track, the lens can be positioned within a range of tracks and the photo-sensor can properly detect the RF signal.

In order to read data on track of disk, seek (searching) is performed to position dual stage moving system over a target region of the spiral track. Track crossings will be detected as the lens is moved radially across the spiral track during seek. The track crossings provide relative position information with respect to an initial position on the disk.

### 2. Description of the Related Art

Access time is an important parameter for performance of data storage device. Access time is the time from the start of one storage device access to the time when the next access is ready and can be started. Access time consists of latency (the overhead of getting to the right place on the device and preparing to access it) and transfer time. Seek time as a major latency is defined as time of moving dual stage mechanical system to target position in optical data storage field.

The requirement to minimize seek time is eliminated in the read only applications of optical device, such as music and movie players where consumers can accept longer access time. CD, DVD, HD and BD recordable engines make the seek time more important in evaluation of those engine performances since the recordable feature require fast data random access. Random seek (search) time becomes an important parameters to evaluate recordable device performance.

Traditionally, two types of seek mode exit in all seeks (searches) in optical storage field. One is defined as long (rough) seek (search) and the other is defined as short (fine) seek (search). In the following description, long (rough) seek (search) is named as long seek and short (fine) seek (search) is named as fine seek. For long seek the sled mechanism and sled motor provides primary positioning of the head assembly and lens. For fine seek, the tracking actuator provides primary positioning of the lens. A tracking actuator drive signal is used to control the tracking actuator.

The seek mode usage depends on required lens travel distance on disk. A long distance travel on disk for lens requires both long seek and fine seek. In order to reduce seek time in long seek mode, maximal force is applied to sled actuator to move head assembly (head) with maximal acceleration and deceleration. Since head center is not aligned with lens center during long seek, the reaction force caused by center distance difference is generated and applied to lens and head each other coupled by spring during the dual stage mechanical settles. Therefore, lens and head cannot settle on the target track but settle on an unknown location of disk. A long seek then is finished with lens and head settlement on wrong track in most case. After the long seek, the optical device needs to read the current location and make decision for next seek to target; long seek or fine seek depending on the track difference from lens current landing track to target track. If the current track is within some distance from target track, for example 1024 tracks, the fine seek will be used to move the dual stage machine to target track. Since the moving distance is shorter, the head center will not drift too much away from lens center before lens center reaches to target track. Based on the assumption, the head and lens can be landed smoothly to target track with a correctable bias force, that is caused by accumulate drifting from head center to lens center during fine seek. It is noticed that long seek and fine seek are both employed to move dual stage machine in a long distance movement on disk. A fine seek cannot be used until the lens and head center can be settled on the location not to far way from required target track after a long seek. Therefore, minimal two accelerations and decelerations are required in best case to finish a long distance movement for the dual stage machine, theoretically. Reading back track location is required to determine the next seek mode (fine or long) after a long seek. The address reading consumes a lot of seek time also. Seek performance is degraded severely. In order to improve seek time performance in optical field, a sensor is normally used to detect the difference between head center and lens center for feedback information for head to be synchronized with lens center movement, such as MO drive and some of DVD OPU. However, the sensor either has poor resolution or is not always equipped on DVD writer mechanism for minimal cost purpose.

3. Objects and Advantages

In order to reduce access time, new servo architecture with dual stage mechanical model is address in this invention. Several objects and advantages of the present invention are to provide
a. A way which can make long seek finished in one time in stead of 2 times in tradition design, theoretically. This can reduce lens access time significantly.
b. Dual stage mechanical models which can be used for control designers have better understanding on dynamical response of lens and head movement.
c. Simplified models for track following and seek modes, respectively. The simplified mechanical models can make implementation be much simpler than before.
d. Estimator designs in track following and seek modes. The design can reduce product cost with accurate distance detection between lens center and head center.
e. Control architecture for track following and seek modes, respectively. The control architecture establishes the control rules for designer to follow.

In addition, there are many concepts to be released in this invention. The concepts are not only to establish control design in optical storage device application, but also make design more simple and cost effective.

### REFERENCES CITED

### US Patent Documents

| | | |
|---|---|---|
| 7120095 | October 2006 | Byung-in et al. |
| 7145838 | December 2006 | Chu, et al. |
| 7038979 | May 2006 | Ceshkovsky |
| 4138663 | February 1979 | Lehureau et al. |
| 4607358 | August 1986 | Maeda et al. |
| 4660191 | April 1987 | Maeda et al. |
| 4677602 | June 1987 | Okano et al. |
| 4779253 | October 1988 | Gertreuer et al. |
| 4797866 | January 1989 | Yoshikawa |
| 4901299 | February 1990 | Nakatsu |
| 4974220 | November 1990 | Harada |
| 4980876 | December 1990 | Abate et al. |
| 5033041 | July 1991 | Schroder |
| 5038333 | August 1991 | Chow et al. |
| 5072434 | December 1991 | Uchikoshi et al. |
| 5179545 | January 1993 | Tanaka et al. |
| 5210726 | May 1993 | Jackson et al. |
| 5381399 | January 1995 | Uehara |
| 5394386 | February 1995 | Park et al. |
| 5459705 | October 1995 | Matoba et al. |
| 5504725 | April 1996 | Katsumata |
| 5610884 | March 1997 | Yanagidate |
| 5638350 | June 1997 | Fuji |

### SUMMARY OF INVENTION

A new seek control architecture and method to reduce seek time is addressed here without lens and head center error (LHCE) detection sensor. The architecture and method is based on a dual stage moving system (see FIG. 1). Based on the model, a multiple stage equation is proposed to describe the model. The multiple stage equation in the invention covers a 4-state-variables state vector, a 2-control-variables control vector and one observing variable. The 4-state-variables state vector describes the dual stage moving system performance including lens position and velocity, head position and velocity during seek. The 2-control-variables control vector describes control forces applied to tracking actuator and sled actuator to move lens and head, respectively. The position measurement for the dual stage moving system can be obtained from observing variable. The specified parameters used to describe the system are varying from drive to drive. The accurate parameters can be derived by drive calibration on power up process from real application viewpoint.

The key point to simplify the dual stage moving system is to neglect reaction force applied to head from lens coupled by spring. The neglect consideration based on an assumption that the head mass is much heavier than lens mass. A simplified dual stage moving system functional block is presented in FIG. 2. The assumption not only makes the mathematic description simple but also decouples the dual stage moving system. The head moving performance is independent of lens moving performance. The decouple results a simple control architecture from both theoretical and real application view point.

According to the mathematic description for dual stage moving system, the control structure in track following mode is presented in FIG. 5. The design consists of two parts: one is closed loop control to lens and another is for head moving closed loop control. In this invention, the control force (TDO) applied to tracking actuator to position lens is claimed to proportional to LHCE signal. Meanwhile the sled actuator is controlled to make head following lens moving. The control (SDO) applied to sled actuator is based on feed back signal LHCE and target LHCE. Therefore, the lens control can be viewed as an estimator design to observer LHCE in a stable closed loop environment for the dual stage moving system.

A control structure in seek mode is presented in FIG. 7. The structure consists of lens distance calculation block; lens velocity control block; LHCE estimation block; head motion control block; simplified dual stage moving system model block and lens position signal generator block. Lens distance calculation block is design to derive a scaled number TPTG proportional to the position difference from current lens position and target lens position. As lens moving toward to target, TPTG is updated dynamically during whole see process. Based on the input of TPTG, the lens moving velocity is controlled by a profile which is a function of TPTG. The output of the block (TDO) is not only used as to control lens moving by tracking actuator but also for LHCE estimation block. LHCE is estimated with TDO, SDO and lens position (LP) signals. The estimated LHCE is compared with target LHCE to generate LHCE error signal. LHCE error adjusted with proper gain and saturation and the coupled control from TDO works together to make head to follow lens movement in head motion control block. Also, as lens movement, the lens position (LP) with respect track on disk is derived in lens position signal generator block. LP is an input signal to lens distance calculation block. In the control structure, the lens acts as master and head always follows the lens movement to minimize LHCE closely.

Seek mode is switched to track following mode as soon as lens reaches to target track and satisfies mode switching criteria set before seek start. The whole system structure including seek and track following mode is presented in FIG. 8. Seek and track following control modes are switched each other by mode switcher. Seek control structure is exactly the same as in FIG. 7 when the mode switcher is set to seek mode and track following control structure is exactly the same as in FIG. 5 when the mode switcher is set to track following mode.

### DRAWINGS

FIG. 1 illustrates a dual stage moving system in optical disk drive application field.

FIG. 2 illustrates a simplified dual stage mechanical model based on the description in FIG. 1

FIG. 3 illustrates simplified mechanical model in track following mode based on FIG. 2

FIG. 4 illustrates control block for track following mode where lens control block is used to estimate LHCE for head control block

FIG. 5 illustrates a decouple structure in seek mode, where head and lens can be positioned individually with minimal coupling effect

FIG. 6 illustrates a mode switch structure to switch from track mode to seek mode and from seek mode to track mode also.

### DETAILED DESCRIPTION OF THE INVENTION

Embodiments of the present invention will be discussed with reference to an optical disc drive. One skilled in the art will recognize that the present invention may also be applied to other data storage device, such as a magneto-optical disk drive

### 1. Mechanical Behavior Description with LHCE Definition

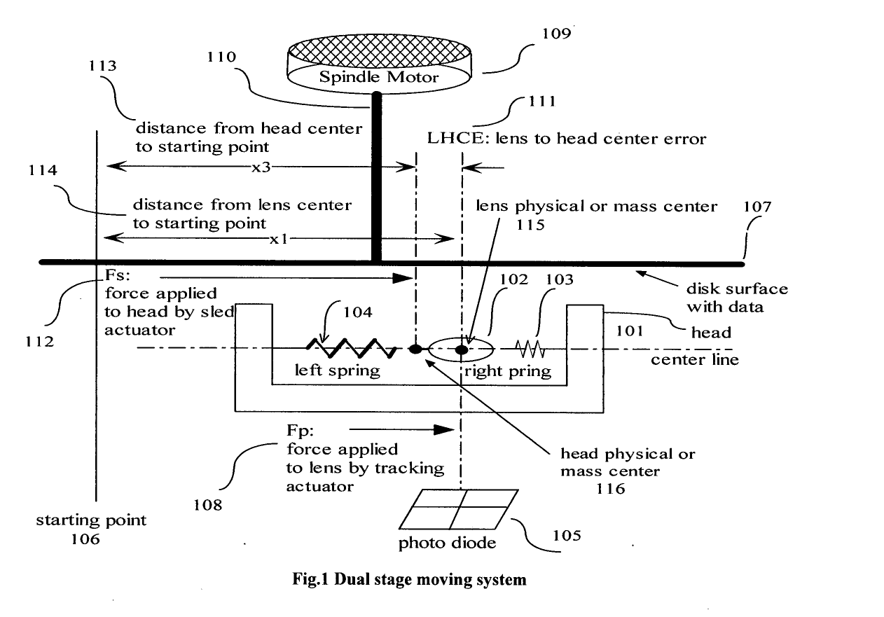

A dual stage moving system is presented in FIG. 1 for the application in optical storage field. A disk 107 is rotated by the spindle motor 109 through a spindle motor axis 110. Photo diode 105 receive reflected laser beam from disk surface where data can be allocated through lens 102. Lens 102 mounted on head 101 is connected through springs 104, 103. Force Fp 108 is applied to lens center 115 through tracking driver to position lens 102 and Force Fs 112 from sled driver is applied to head center 116 to position head 101. Starting point 106 is a common reference for the measurement of lens 102 and head 101 position. Starting point could be any where as long as the reference number is not changed during lens and head position measurement. x1 114 is distance from lens center 115 to starting point 106. x3 113 is distance from head center 116 to starting point 106. LHCE 111 is defined as lens to head center error, i.e. LHCE=x1−x3.

Force Fp 108 applied to lens center 115 moves lens 102 to a position measured by track on a disk 107, another force Fs 112 applied to head moves head center 116 to a position in the dual stage mechanical movement. LHCE 111 will vary as lens and head are moving together. The variation will result spring force to react on lens and head, respectively. In order to achieve the smooth landing, the lens to head center error 111 should be kept minimal in all movement processes to avoid large bias force during lens and head settle. If head center 116 can always be aligned with lens center 115 during whole moving process, the long seek can be finished in one time with reliable settle on target track because the bias force to lens caused by LHCE is eliminated. The design target for the dual stage moving system is to position lens followed by head with a minimized LHCE.

### 2. Simplified Mechanical Model

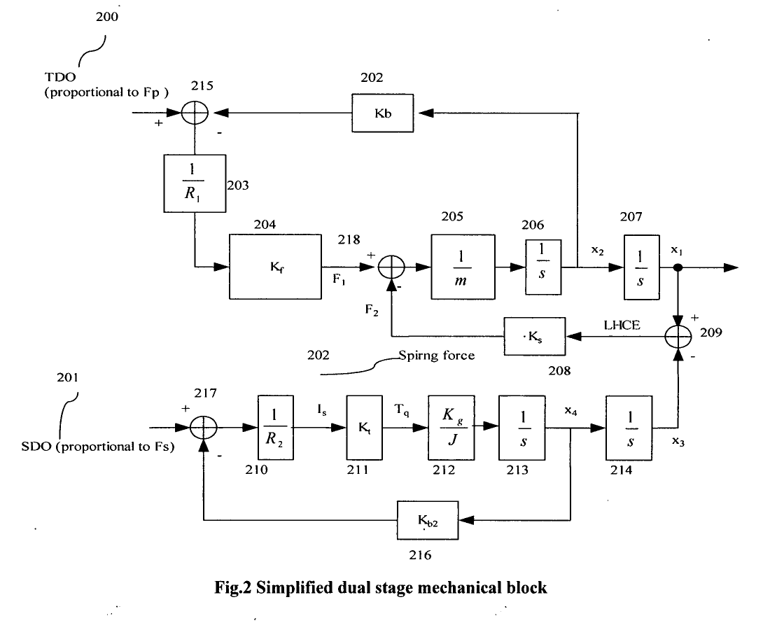

According to descriptions above, a simplified mechanical model is presented in FIG. 2 for the dual stage mechanical system in FIG. 1. Since head mass is much larger than lens mass, the reaction force applied to head is neglected to simplify dynamical response analysis of the dual stage mechanical system. The consideration results in the decoupled analysis for lens and head system, respectively. It is noticed that head system controlled by SDO 201 generates a reaction force proportional to difference between x1 114 and x3 113, but the reaction force applied to head system is neglected. TDO 200 and SDO 201 are the control voltages applied to tracking actuator and sled actuator to generate control forces Fp 108 and Fs 112, respectively. The symbols are defined as follows (x1 and x3 refer to FIG. 1 114 and 113)
x1: distance from lens center 115 to starting point 106.
x2: lens moving velocity
x3: distance from head center 116 to the starting point 106.
x4: head moving velocity
R1 203 and R2 210 are motor driver parameters.
Kb 202 and Kb2 216 are Back Electromagnetic Field (BEMF) to tracking actuator and sled actuator.
Ks 208: Spring coefficient. The springs 103, 104 are used to connect head and lens.
m 205 and J 212: lens 102 and head 101 mechanical masses.
Kf 211: mechanical coefficient of tracking actuator.
Kg and Kt 211: mechanical coefficients of sled actuator 102.

The major parameters are considered in FIG. 2. Some parameters with small contribution to the dual stage movement are neglected, such as the small reaction force applied to head 101 due to lens center 115 moving away from head center 116 is not considered in this model. Also the friction forces for lens and head movement are not counted. Based on the simplified mechanical model presented in FIG. 2, following formulas are obtained.

### For Lens Model

$$\begin{matrix}x {1}^{′} = x 2 & ( 2.1 ) \\ \begin{matrix}x {2}^{′} = [ ( TDO - Kb * x 2 ) * Kf / R 1 - Ks * ( x 1 - x 3 ) ] / m \\ = - Kb * Kf * ( 1 / R 1 ) * ( 1 / m ) * x 2 - Ks * ( 1 / m ) * \\ ( x 1 - x 3 ) + Kf * ( 1 / R 1 ) * ( 1 / m ) * TDO \\ = A * x 2 + B * ( x 1 - x 3 ) + C * TDO\end{matrix} & ( 2.2 )\end{matrix}$$

### Where x1′ is derivatives of x1, x2′ is derivatives of x2,

A=−Kb*Kf*(1/R1)*(1/m),

B=Ks*(1/m),

C=Kf*(1/R1)*(1/m)

### For Head Model

$$\begin{matrix}x {3}^{′} = x 4 & ( 2.3 ) \\ \begin{matrix}x {4}^{′} = ( SDO - Kb 2 * x 4 ) * Kt * Kg * ( 1 / R 2 ) * ( 1 / J ) \\ = - Kb 2 * Kt * Kg * ( 1 / R 2 ) * ( 1 / J ) * x 4 + Kt * Kg * \\ ( 1 / R 2 ) * ( 1 / J ) * SDO\end{matrix} & ( 2.4 )\end{matrix}$$

### Where, x3′ is derivatives of x3, x4′ is derivatives of x4,

D=Kb2*Kt*Kg*(1/R2)*(1/J),

E=Kt*Kg*(1/R2)*(1/J)

With Eq. (2.1), Eq. (2.2), Eq. (2.3) and Eq. (2.4), the following state equations are obtained:

$$\begin{matrix}\begin{matrix}{X}^{′} ( t ) = [ \begin{matrix}x {1}^{′} \\ x {2}^{′} \\ x {3}^{′} \\ x {4}^{′}\end{matrix} ] \\ = [ \begin{matrix}0 & 1 & 0 & 0 \\ B & A & - B & 0 \\ 0 & 0 & 0 & 1 \\ 0 & 0 & 0 & D\end{matrix} ] [ \begin{matrix}{x}_{1} \\ {x}_{2} \\ {x}_{3} \\ {x}_{4}\end{matrix} ] + [ \begin{matrix}0 & 0 \\ C & 0 \\ 0 & 0 \\ 0 & E\end{matrix} ] [ \begin{matrix}TDO \\ SDO\end{matrix} ] \\ = Φ X ( t ) + Γ U ( t )\end{matrix} & ( 2.5 ) \\ \begin{matrix}y ( t ) = [ \begin{matrix}1 & 0 & 0 & 0\end{matrix} ] [ \begin{matrix}{x}_{1} \\ {x}_{2} \\ {x}_{3} \\ {x}_{4}\end{matrix} ] \\ = λ X ( t )\end{matrix} & ( 2.6 )\end{matrix}$$

All mechanical dynamical response can be derived from the 4^{th} order state equation Eq. (2.5) and Eq. (2.6), which will be used to do control design for the dual stage mechanical system.

### 3. Control Architectures and Estimator in Track Following Mode

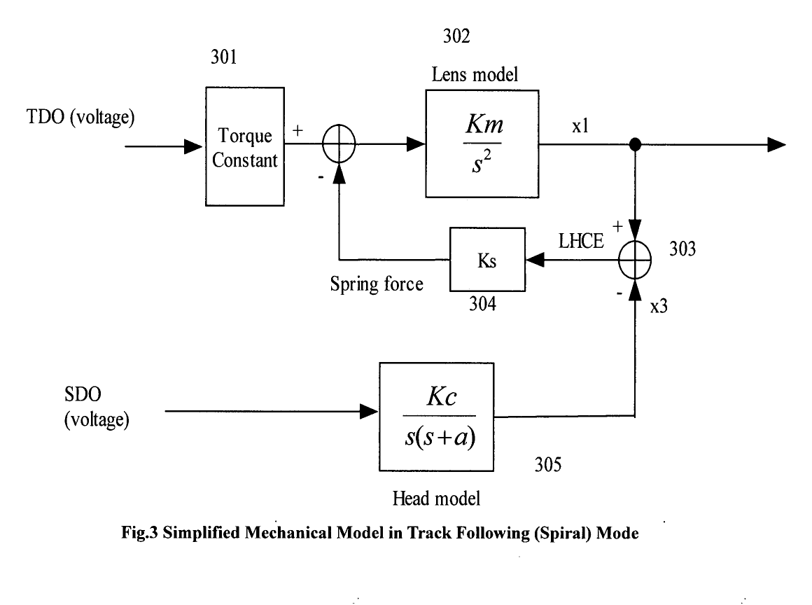

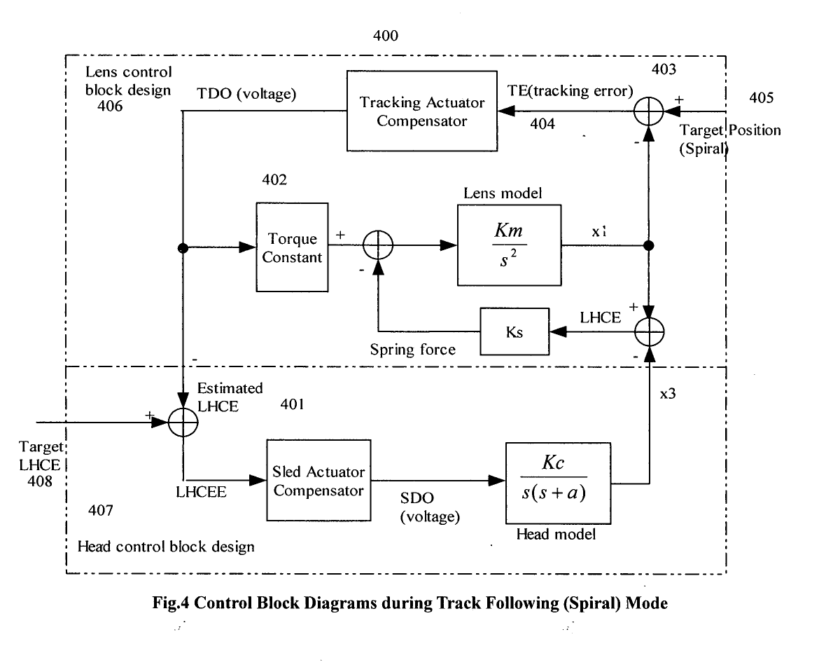

In the section, a further simplification on model is presented in FIG. 3 for track following mode. Dynamical responses of head model 305 and lens model 302 are presented in a simpler form by neglecting the contribution BEMF Kb 202 due to the slow movement in track following mode. The couple effect between lens 302 and head 305 is introduced through summing function 303 and spring coefficient 304. Control architecture in FIG. 4 is presented for head and lens movement. Target position 405 generated from track center is an input signal to lens position system. The target center 405 is increased linearly in radial displacement as disk 107 spirals by spindle motor rotation. The input 405 is compared with lens current position x1 114 and tracking error signal (TE) 404 is derived. The tracking actuator compensator 400 compensates the lens and tracking driver to be a stable system. And its output TDO 200 positions the lens location. All the function blocks related to lens movement are defined as lens control block 406 with 2 inputs and one output. Input counts on Target position 405 and head current location x3 113, output is TDO 200 Head control block 407 has 2 inputs and one output also. One input is from lens control block output TDO 200 and another one is target LHCE 408 that is proportional to desired difference between lens center 115 and head center 116 for the dual stage system movement. The target LHCE 408 is set to zero in normal practice.

Since lens movement is really slow and constant, Velocity x2 and acceleration x2′ of lens movement are closed to zero. From the reasonable assumption

x2=x2′=0 (3.1)

and Eq. (2.2), the following relationship can be derived

B*(x1−x3)+C*TDO=0

B*LHCE=−C*TDO (3.2)

The mathematical analysis can be explained as that the feedback voltage through Kb 202 is not significant since the velocity and acceleration are very small during spiral mode (track following). In order to spiral smoothly (acceleration=0), the force F1 218 should be very close F2 (spring force 202) with proper gain setup to meet the assumption Eq. (3.1). While F2 spring force 202 is proportional to LHCE 111, the control voltage (TDO 200) for lens system in track following mode should be proportional to LHCE also. The statement has been proved in Eq. (3.2). In another word, a stabilized lens closed loop system can be viewed as LHCE estimation system with the TDO as the estimation system output during track following mode. The TDO (estimated LHCE) is used as feedback signal for head closed loop control. Therefore, the two inputs and one output system (dual stage system) can be separated as two individual control systems, lens control block 406 and head control block 407. Lens control block is used as LHCE 111 estimation (TDO) and head control block is used to minimize the difference between target LHCE 408 and estimated LHCE. In another word, head is controlled to follow the lens center with target LHCE while lens center follows the track center. A sled actuator compensator 401 can stabilize the head control block and output SDO. If LHCE is zero, i.e. the same centers for lens and head during track following movement, TDO should be closed to zero.

### 4. Lens and Head with Tracking and Sled Actuator Control Architecture in Seek Mode

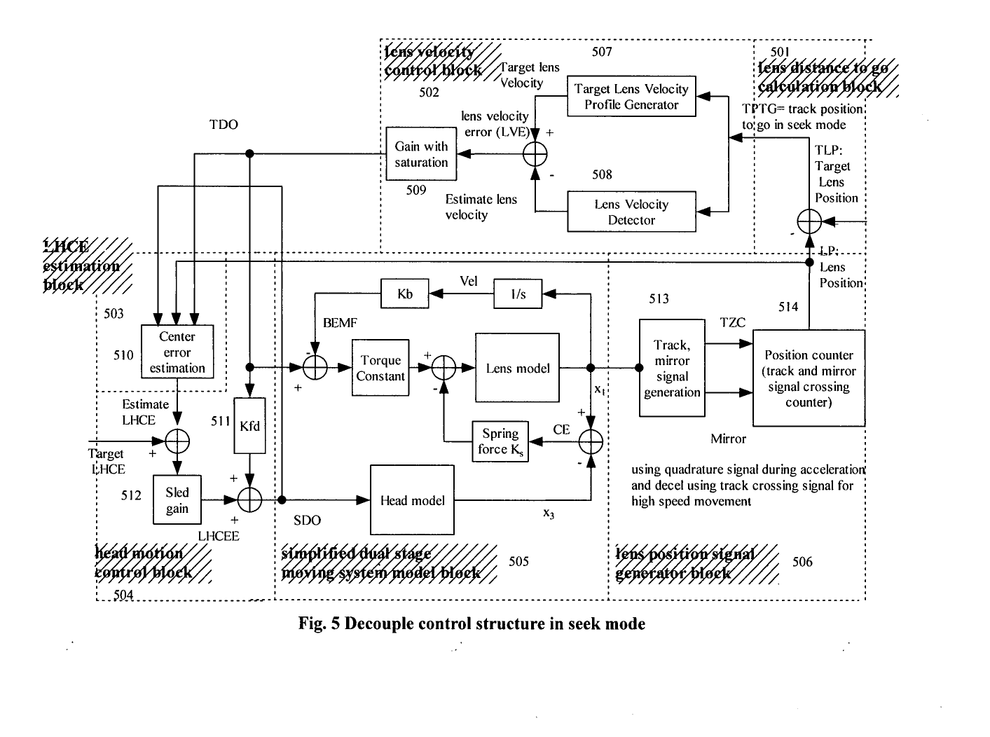

FIG. 5 shows the control block diagram for the lens 102 and head 101 movements in seek mode. The block diagram contains following blocks:

Simplified dual stage moving system model block 505.This block for dual stage mechanical system is different from model in track following by considering the BEMF contribution Kb 202 due to fast moving speed.

Lens position signal generation block 506. Lens position signal counted in track crossing are generated in this block. Lens center location on disk x1 114 is modulated to track crossing (TZC) and mirror signals. A counter with quarter track resolution is developed to count lens center position on disk. The counter can also figure out the positive track and minas track depending on lens center movement direction. The counter output is defined as Lens position (LP) and inputs to the lens distance to go calculation block 501. The detailed description to generate current position signal is given in another invention.

Lens distance to go calculation block 501. Target lens position TLP is compared with current LP from block 506 to generate track position to go (TPTG) signal. TPTG is input to block 502.

Lens velocity control block 502. Target lens velocity profile generator 507 can generate target velocity in the function of TPTG. There is many way to do the profile design, such as table search or formula form or other ways. The most important thing for the velocity profile design 507 is to consider the implementation availability in real application environment. Too complex design will be unpractical in real implementation, but too simple design will also result a bad resolution to lead the lens moving speed to target track. Lens velocity detector 508 is used to calculate the lens moving speed in quarter track resolution. There are still many way to estimate or calculate lens velocity feedback. Lens velocity error comes from the difference between target lens velocity and estimate lens velocity and is used as input to gain with saturation block 509. The gain is saturated on both bottom and top to insure the control effort TDO 200 within limit. The saturated gain outputs to block 503. The detailed descriptions for profile design and lens center velocity detection are given in another invention

LHCE estimation block 503. In order to know the difference between lens center and head center, LHCE 111, the center error estimation 510 is implemented. The estimator 510 has 3 inputs consisting of TDO, SDO and LP, and one output estimated LHCE. The estimator can be designed in many different ways, such as open loop estimator or closed loop estimator or reduced order closed loop estimator or other form. Input and output signal number can be vary differently depending on the implementation way. The estimators are useful for those cases where no sensor is available to measure LHCE 111 with a proper resolution. The detailed description for LHCE estimator is given in another invention Head motion control block 504. The output signal estimated LHCE from estimator 510 is compared with target LHCE where is normally set to zero. The difference after the comparison is amplified with saturation gain. TDO 200 amplified by Kfd 511 works with LHCE error (LHCEE) together to drive SDO 201. By set different sled gain 512 and Kfd 511, the head centers 116 can follows the lens center 115 movement with minimal LHCEE or LHCE if target LHCE is set to zero.

### 5. Switching Structure between Track Following and Seek Mode

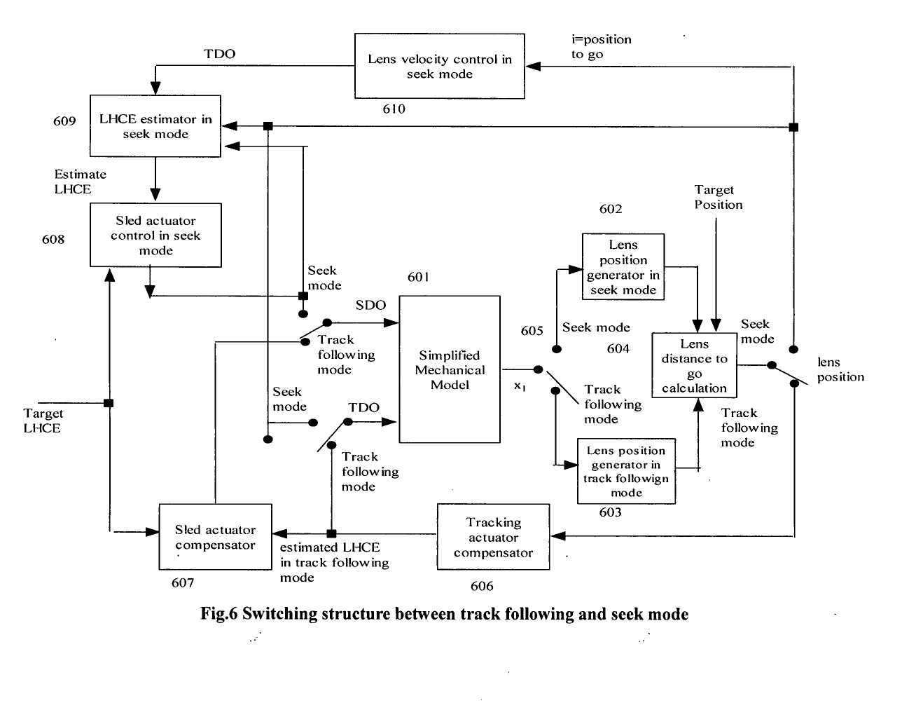

There are 2 modes for the dual stage mechanical movement as stated above. The switch structure between the modes is presented in FIG. 6. Switcher 605 is used to operate mode switching function according to different criteria. The criteria could be preset before a seek start and adjust dynamically depending on application. The switcher can set 2 modes, seek mode and track following mode and be used in many place in FIG. 6. If the switcher is connected to track following mode, the seek mode will not operate and all functions are the same as those described in FIG. 4. If the switcher 605 is set to seek mode, the track following mode will not operate and all function in the case will be the same as those described in FIG. 5.

In this way, the invention gives the dual stage mechanical control structure. Since the LHCE estimation is introduced, the control scheme is systemized based on the simplified mechanical model in different modes. This results a uniform control rule for any seek length and makes one time seek be practical. Therefore, the access time for dual stage mechanism movement is reduced.

The foregoing description, for purposes of explanation, used specific nomenclature to provide a thorough understanding of the invention. However, it will be apparent to one skilled in the art that the specific details are not required in order to practice the invention. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the claims and their equivalents, rather than by the example given.

I claim:

1. Simplified dual stage mechanical structure drawing (see FIG. 1) to position optical lens center for optical disk drive. Lens is mounted on head with spring connection and positioned by tracking actuator (normally voice coil motor but not limited). Head is mounted on sled and positioned by a sled actuator (normally DC motor or step motor but not limited). Force Fp is applied to lens mass or physical center through tracking actuator in dual stage mechanical moving direction. Force Fs is applied to head mass or physical center through sled motor in dual stage mechanical moving direction.

2. Definition of lens position measurement (see FIG. 1) including
x1=distance from lens center to starting point
x3=distance from sled center to starting point
LHCE=distance from lens center to head center error
Free starting point and said lens and head center could be mass center or physical center but not limited to other centers those forces are applied to.
Force applied to lens moves lens to a position measured by track on a disk, another force applied to head moves head to a position in the dual stage mechanical movement stated in claim 1.a. LHCE is minimized to zero or a target value through controlling said two different forces in the dual stage mechanical movement in claim 1.a.

3. Block diagram (see FIG. 2) for simplified dual stage mechanical connection drawing including a set of parameters as follows
Tracking actuator parameter includes motor coil resistant R1, Back Electromagnetic Field (BEMF) Kb1, mechanical inertial m and mechanical coefficient Kf.
Sled actuator parameter includes motor coil resistant R2, Back Electromagnetic Field (BEMF) Kb2, mechanical inertial J, torque constant Kt and Gear gain Kg.
Ks: Spring coefficient to apply force on lens and sled

4. Reaction force applied to head from lens during the dual stage mechanical movement is neglected.

5. Use state variables to describe dynamic movement in claim 3. 4 state variables (but not limited to 4) are defined as following
x1: distance from lens center to starting point
x2: said lens moving velocity and is derivatives of x1
x3: distance from head center to starting point
x4: said head moving velocity and is derivatives of x3

6. Voltage or current driver circuits to generate voltage or current,
Tracking driver (voltage or current driver) output (TDO) is applied to tracking actuator
Sled driver (voltage or current driver) output SDO is applied to sled actuator

7. Observe variable y resulted from state variables combination in claim 5.

8. Using multiple dimensional state equations and observing equation structure to describe the dual stage mechanical movement claim 3 with state variables in claim 5, control variables in claim 6 and observe variable in claim 7.
$$\begin{matrix}{X}^{′} ( t ) = [ \begin{matrix}x {1}^{′} \\ x {2}^{′} \\ x {3}^{′} \\ x {4}^{′}\end{matrix} ] \\ = [ \begin{matrix}0 & 1 & 0 & 0 \\ B & A & - B & 0 \\ 0 & 0 & 0 & 1 \\ 0 & 0 & 0 & D\end{matrix} ] [ \begin{matrix}{x}_{1} \\ {x}_{2} \\ {x}_{3} \\ {x}_{4}\end{matrix} ] + [ \begin{matrix}0 & 0 \\ C & 0 \\ 0 & 0 \\ 0 & E\end{matrix} ] [ \begin{matrix}TDO \\ SDO\end{matrix} ] \\ = Φ X ( t ) + Γ U ( t )\end{matrix}$$
$$\begin{matrix}y ( t ) = [ \begin{matrix}1 & 0 & 0 & 0\end{matrix} ] [ \begin{matrix}{x}_{1} \\ {x}_{2} \\ {x}_{3} \\ {x}_{4}\end{matrix} ] \\ = λ X ( t )\end{matrix}$$
Where x1′ x2′ x3′ x4′ is derivative of x1, x2, x3, and x4 respectively

9. Derived matrix coefficients for claim 8 based on claim 4
A=−Kb*Kf*(1/R1)*(1/m),
B=Ks*(1/m),
C=Kf*(1/R1)*(1/m),
D=Kb2*Kt*Kg*(1/R2)*(1/J),
E=Kt*Kg*(1/R2)*(1/J)

10. Simplified dual stage mechanical structure in track following mode (see FIG. 3) base on claim 8

11. Decouple the dual stage mechanical system in track following mode, where moving velocity x2 and acceleration x2′ for lens are very small and can be neglected. LHCE is proportional to x1-x3 stated based on claim 8. The proportional relationship is described as followings but not limit to that
B*(x1−x3)+C*TDO=0,
Which results LHCE is proportional to x1−x3=−TDO*C/B

12. Decouple closed loop control structure presented in FIG. 4.
Lens control block structure design. The lens distance with respect to track displacement is coupled to the photo sensor through lens. A feedback signal defined as x1 is obtained from photo sensor mounted on head. A target position signal is changed gradually as lens moves to disk out diameter (OD), spirally. The feedback signal x1 is compared with the target position and a tracking error (TE) signal is generated. The tracking actuator compensator applied by its input signal TE generates TDO to control tracing actuator for lens movement.
Head control block structure design. TDO signal is compared with target LHCE to generate the error signal (LHCEE). The said error signal is applied to sled actuator compensator to control the head movement (x3). The position difference between head center and lens center (x1-x3) generate estimated LHCE. The estimated LHCE is proportional to a spring force applied to lens for lens movement. The spring force applied to head from LHCE is neglect reasonably.
Lens control block design is used as an estimator of LHCE in the stable decouples closed loop control structure. The estimator's inputs are head center position and target position. Its output is tracking actuator compensator output TDO.
Estimated LHCE is proportional to tracking actuator compensator output TDO and used as feedback signal for head moving system.
The closed loop dual stage system is stable if and only if TE and LHCEE signal are a constant or zero in all time

13. Decouple closed loop control structure in seek mode presented in FIG. 5.

14. Lens distance to go calculation block in seek mode. Target track number as input to this block compares with lens position with respect to tracks on disk input from lens position signal generator block. A scaled calculation is implemented and the scaled position to go in seeks mode (TES) outputs to the lens velocity control block.

15. Lens velocity control block. Lens velocity is detected and lens target velocity profile is generated based on TES. Lens velocity error (LVE) is obtained by comparing estimated lens velocity and target lens velocity from lens velocity profile generator. TDO is generated with gain limit control by saturating very large number on the amplified LVE. TDO outputs to head motion control block to control sled actuator with estimated LHCE. Also, TDO outputs to tracking actuator in the simplified mechanical block to control lens moving velocity.

16. Head motion control block includes 4 inputs: TDO, SDO, lens position and target LHCE; one output SDO. Two functions are achieved in the block. One function is to estimate LHCE and another function is to control sled actuator, described as follows
LHCE estimator design used to estimate LHCE can be achieved in open loop and closed loop forms with different estimator order. TDO, SDO and lens position signals works together with estimator design to generate estimated LHCE
The estimated LHCE is compared with target LHCE as one part of control effort on sled motion. TDO signal amplified by Kfd is used as another control effort on sled movement. The 2 effort summation is applied to sled actuator for head position
Lens is controlled by tracking actuator according to target profile which is a function of lens position. Head follows the lens movement by sled actuator control. The basic control rule during the dual stage movement is to minimize the error LHCEE between target LHCE and estimated LHCE.

17. Lens position generator block structure. Track cross on disk is optically coupled to photo sensor through lens. The track cross generate track crossing (TZC) and mirror signals. TZC and mirror signals are plus and minus 90 degree phase shift depend on lens moving direction. A track crossing signal with quartered track resolution is generated. The quartered track signal is applied to lens distance to go calculation block.

18. One time seek for lens moving any distance. A seek is defined as moving lens from current position to target position, where position is location referred to a reference starting point. Traditional, the lens movement control is classified to 2 steps: long seek (search) and fine seek (search) in optical storage field depending on seek (search) length. Long seek (search) and fine seek (search) employ different control methods, respectively. The control structure in claim 4 is available for any seek (search) length.

19. Mode switching structure in FIG. 6
Switchers between track following mode and seek mode
One seek (search) process includes mode switches from track following mode to seek mode and seek mode back to track following mode. The switchers are controlled during the said seek (search) process.
Set switcher to track following mode is the basic structure for decouple closed loop control in track following mode in claim 3
Set switcher to seek mode is the basic structure for decouple closed loop control in seek mode in claim 4
